(19) United States
(12) Patent Application Publication
(10) Pub. No.: US 2008/0121549 A1
(43) Pub. Date: May 29, 2008

(54) PAINT TRAY

(76) Inventor: Joseph Bartok, Thorold (CA)

Correspondence Address: GOWLING, LAFLEUR HENDERSON LLP, ONE MAIN STREET WEST, HAMILTON, ON, L8P 4Z5, omitted

(21) Appl. No.: 11/935,755

(22) Filed: Nov. 6, 2007

Related U.S. Application Data
(60) Provisional application No. 60/861,266, filed on Nov. 28, 2006.

(51) Int. Cl. B65D 1/34; B44D 3/00; B65D 25/22

(52) U.S. Cl. 206/557; 206/1.7; 220/737

(57) ABSTRACT

A paint tray has a tray-like main body with a base surrounded by front, rear and side walls for retaining paint therein. The side walls have upwardly and rearwardly extending attachment portions adjacent their rear ends. The attachment portions have curved end portions above the rear wall to enable the tray to be attached to laterally spaced uprights of a ladder by engaging the curved end portions with respective uprights, with other portions of the tray engaging the uprights below the curved end portions.

### RELATED APPLICATION

This application claims priority from U.S. provisional patent application No. 60/861,266 filed Nov. 28, 2006.

### FIELD OF INVENTION

This invention relates to paint trays.

### BACKGROUND OF THE INVENTION

Different kinds of paint trays have been used for many years, but there is still a need for a paint tray of relatively simple construction which can be placed on the floor or table and also can be attached to a ladder. It is therefore an object of this invention to provide a paint tray which meets such requirements.

### SUMMARY OF THE INVENTION

According to the invention, a paint tray has a tray-like main body with a base surrounded by front, rear and side walls for retaining paint therein, the side walls having upwardly and rearwardly extending attachment portions adjacent their rear ends, the attachment portions having curved end portions above the rear wall to enable the tray to be attached to laterally spaced uprights of a ladder by engaging the curved end portions with respective uprights, with other portions of the tray engaging the uprights below the curved end portions.

The attachment portions may have recesses adjacent the rear wall for engaging the ladder uprights and enabling the rear wall to be positioned between the uprights.

The rear end of the tray may have a pair of hook-shaped legs securable to a rung of a ladder.

### DESCRIPTION OF THE DRAWINGS

One embodiment of the invention will now be described, by way of example, with reference to the accompanying drawings, of which:

FIG. 1 is a perspective view of a paint tray in accordance with one embodiment of the invention mounted on a stepladder,

FIG. 1a shows an enlarged perspective view of one of the rear legs of the tray,

FIG. 2 is a perspective view of a portion of the tray showing a holder for an edger attached thereto, and

FIG. 3 is similar view to FIG. 2 but shows a holder for a paint brush attached to the tray.

### DESCRIPTION OF PREFERRED EMBODIMENTS

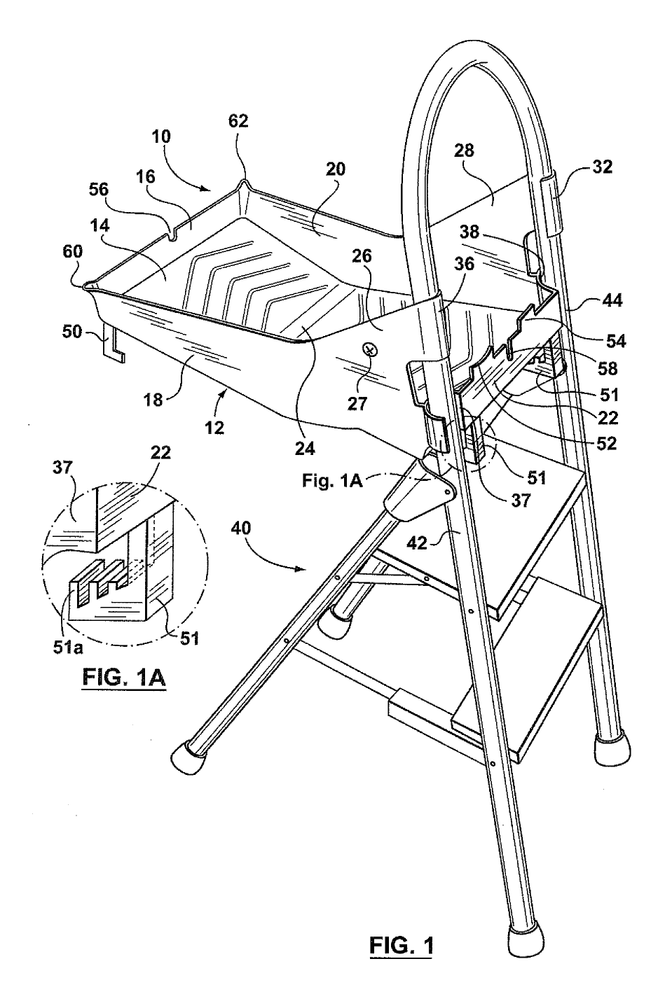

Referring first to FIG. 1 and FIG. 1a, a paint tray 10 which may be of suitable plastic material has a tray-like main body 12 with a rectangular base 14 surrounded by a front wall 16, side walls 18, 20 and a rear wall 22 for retaining paint therein. The base 14 slopes downwardly from both the front wall 16 and the rear wall 22 to a lowermost level halfway along the tray.

Each side wall 18, 20 has an upwardly and rearwardly extending attachment portion 26, 28 adjacent its rear end, and each attachment portion 26, 28 has a curved end portion 30, 32. Each curved end portion 30, 32 is engagable with the laterally-spaced uprights 42, 44 of a step-ladder 40. The attachment portions 26, 28 also have recesses 37, 38 below the curved end portions 30, 32 and adjacent the rear wall 22 which engage the uprights 42, 44, thereby securing the tray 10 to the ladder 40 as shown in the drawings. The recesses 37, 38 also enable the rear wall 22 to be positioned between the ladder uprights 42, 44. Thus, the step-ladder 40 can easily be moved from one location to another with the paint tray 10 attached thereto.

The front end of the tray 10 has legs 50 and the rear end of the tray has a pair of laterally spaced legs 51 to enable the tray to be placed on the ground in a level condition when desired, for example on the floor or on a table top. As shown in FIG. 1a, the rear legs 51 are hook-shaped with upwardly extending fingers 51a to enable the tray 10 to be secured to the rung of a long ladder instead of to a step-ladder. Also, attachment portion 26 is provided with a cloth holder in the form of an aperture 27.

The upper edge of the rear wall 22 may have a large part-circular recess 52 and a small part-circular recess 54 to enable a large or small paint roller to be pulled across the recess upper edge to wipe excess paint from the roller, which paint then falls back into the tray. Also, the front and rear walls 16, 22 may have a central notch 56, 58 in their upper edges into which a part of the paint roller handle may be placed to retain a paint roller in a suitable position in the tray. Further, the front corners 60, 62 of the tray 10 may be shaped to function as pouring spouts to empty the tray.

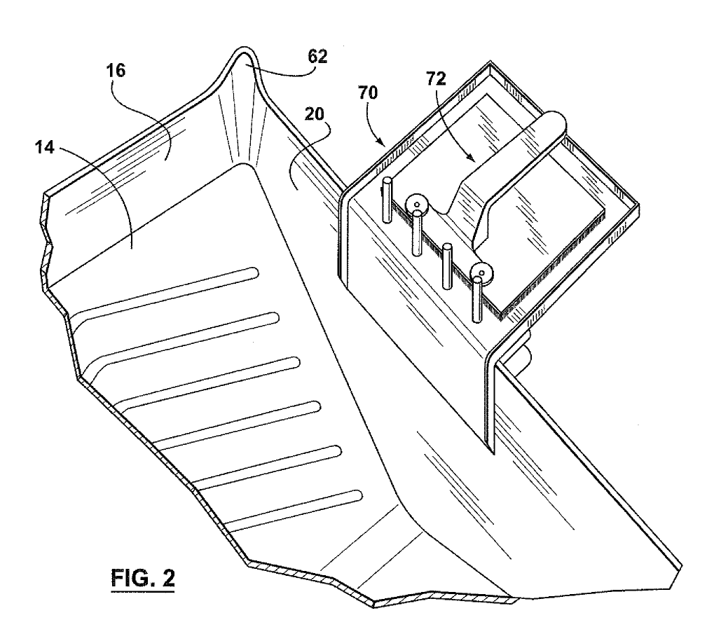

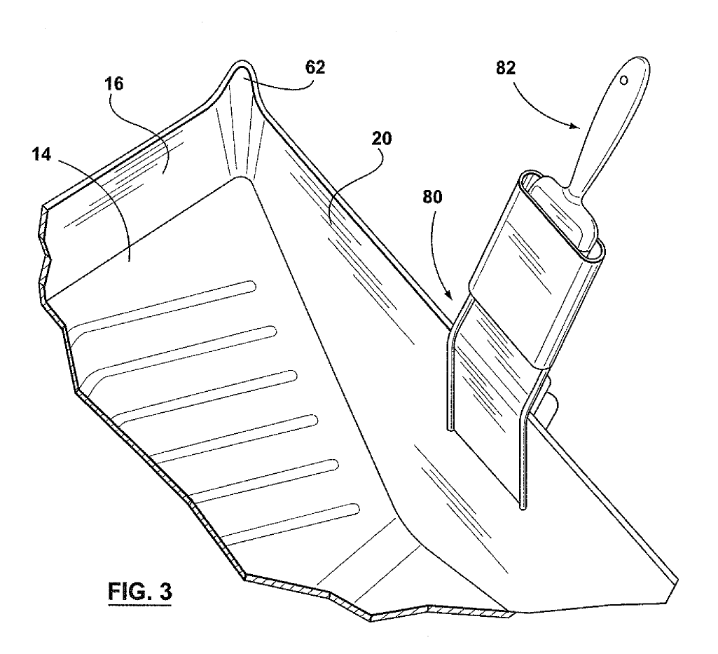

FIG. 2 shows how a holder 70 for an edger 72 may be detachably secured to a side wall of the tray, and FIG. 3 shows how a holder 80 for a paintbrush 82 may be detachably secured to a side wall of the tray in such a manner that paint dripping from the brush 82 runs into the tray.

The advantages of the invention will now be readily apparent to a person skilled in the art from the foregoing description of preferred embodiments. Other advantages and embodiments will also now be readily apparent, the scope of the invention being defined in the appended claims.

1. A paint tray having a tray-like main body with a base surrounded by front, rear and side walls for retaining paint therein, the side walls having upwardly and rearwardly extending attachment portions adjacent their rear ends, the attachment portions having curved end portions above the rear wall to enable the tray to be attached to laterally spaced uprights of a ladder by engaging the curved end portions with respective uprights, with other portions of the tray engaging the uprights below the curved end portions.

2. A paint tray according to claim 1 wherein the attachment portions have recesses adjacent the rear wall for engaging the ladder uprights and enabling the rear wall to be positioned between the uprights.

3. A paint tray according to claim 1 wherein the rear end of the tray has a pair of hook-shaped legs securable to the rung of a ladder.
